(19) United States
(12) Patent Application Publication
(10) Pub. No.: US 2007/0004440 A1
(43) Pub. Date: Jan. 4, 2007

(54) Method for transmitting data from a transmitting station to a receiving station via a radio link, and corresponding receiving station and transmitting station

(76) Inventors: Volker Breuer, Botzow (DE); Frederic Charpentier, Berlin (DE)

Correspondence Address: STAAS & HALSEY LLP, SUITE 700, 1201 NEW YORK AVENUE, N.W., WASHINGTON, DC, 20005, US

(21) Appl. No.: 10/556,687

(22) PCT Filed: Apr. 21, 2004
(86) PCT No.: PCT/EP04/50578

§ 371 Date: Nov. 14, 2005

(30) Foreign Application Priority Data
May 12, 2003 (DE) 103212051

(51) Int. Cl. H04B 1/00; H04B 7/00

(52) U.S. Cl. 455/522; 455/63.1

(57) ABSTRACT

A radio link is set up from a transmitting station to a receiving station for the transmission of data after a time interval has elapsed. The time interval is specific to the transmitting station and has a duration which depends on at least one deterministic quantity.

### CROSS REFERENCE TO RELATED APPLICATIONS

This application is based on and hereby claims priority to German Application No. 10321205.1 filed on May 12, 2003, the contents of which are hereby incorporated by reference.

### BACKGROUND OF THE INVENTION

1. Field of the Invention

The invention relates to a method for transmitting data from a transmitting station to a receiving station via a radio link, and to a corresponding receiving station and a corresponding transmitting station.

2. Description of the Related Art

In radio communication systems that use a CDMA procedure (CDMA: Code Division Multiple Access) for subscriber separation, the transmission capacity in the uplink (or reverse link) direction, i.e. from a subscriber station to a base station, is limited by the interference level existing at the base station. The interference level can be characterized by a so-called “noise rise” which is defined as the ratio of the total received power to the power of the thermal noise. The noise rise is influenced by the number of transmitting subscriber stations, the power of the signals of the subscriber stations received at the base station and other sources that generate noise.

Base stations at which a significant increase in noise rise occurs suffer from instabilities (cell breathing) which can cause deterioration of transmitted services and reduced cell coverage.

It is therefore essential for the operation of a radio access network, for example, the UTRAN (Universal Terrestrial Radio Access Network) in a radio communication system conforming to the UMTS standard (UMTS: Universal Mobile Telecommunication System), to control the noise rise, in that appropriate restrictions for uplink transmissions are defined by the network, i.e. by UTRAN.

In controlling noise rise two aspects should be taken into account:
The mean value of the noise rise should be kept below an upper limit (a typical value here is 6 dB).
The fluctuation of noise rise over time, i.e. the variance of a noise rise distribution function, should be as small as possible.

Up to now UTRAN has been able to define the maximum transmission power of subscriber stations by corresponding signals (3 GPP [3rd Generation Partnership Program] 25.133v 5.6.0, chapter 6.5), in order to control the mean value of noise rise. The signals are generated by a Radio Resource Controller (RNC) and transmitted to the subscriber stations via base stations. The disadvantage of this type of signaling lies in relatively long signal durations, i.e. signal delays, which prevent precise control of noise rise.

To control the fluctuations in noise rise, a fast power control loop can be used (3 GPP 25.214v5.4.0, chapter 5.1.2). However, this is unsuitable if the total power received at the base station is not constant. This is the case, for example, with a transmission of data packets that takes place not continuously but in radio bursts, through new active subscriber stations or through a change in a reference value of the reception quality (e.g. SIR [Signal to Interference Ratio]) of a subscriber station.

A further possible way of controlling the fluctuation of noise rise is to use a Medium Access Protocol called a DRAC (Dynamic Resource Allocation Protocol) (3 GPP 25.331v5.4.0, chapter 14.8 and EP 1033846 A1). This protocol is intended to reduce statistically the number of data transmissions taking place simultaneously by determining the start of a data transmission for a subscriber station by a random function.

Methods which make possible transmission of data packets with increased data rates in the uplink direction are currently being discussed under the designation “enhanced uplink” (3 GPP TR25.896v0.3.0) in the context of the standardization project of 3 GPP (3rd Generation Partnership Project). However, access to a transmission medium by the DRAC protocol is not designed to make possible high data rates for data transmission in the uplink direction. The maximum data throughput is limited to 512 Kbits/s (cf. 3 GPP 25.331v5.4.0, chapter 10.3.3.20).

Known from the document “Scheduled and Autonomous Mode Operation for Enhanced Uplink”, 3 GPP TSG RAN WG1#31, Tdoc R1-03-0284, pages 1-7, XP-002298746, is a method whereby a Node B determines which subscriber stations may transmit in the uplink direction. The start time and duration of the data transmissions of the subscriber stations are fixed. In the decision of Node B as to which subscriber stations have permission to transmit data, and in the selection of a data rate or a transmission power for these subscriber stations, Node B takes account, for example, of the following parameters: memory status of each subscriber station, transmission power limitation of each subscriber station, channel quality estimation for each subscriber station or permitted noise rise until attainment of the Rise over Thermal (RoT) limit at Node B.

### SUMMARY OF THE INVENTION

It is therefore an object of the invention to provide a method for data transmission with which a transmitting station can so control its data transmission that a reduction in the interference level at a receiving station can be achieved.

In a method according to the invention for transmitting data from a transmitting station to a receiving station via a radio link, the radio link is set up between the transmitting and the receiving station and the data transmission begins only after the expiration of a first time interval specific to the transmitting station, the duration of which time interval depends on at least one deterministic quantity. Through the lapse of an individual first time interval up to the start of the data transmission, a statistical distribution of data transmissions of a plurality of transmitting stations is achieved. In this way the probability of an accumulation of simultaneous data transmissions of a plurality of transmitting stations and a resulting high interference level at the receiving station is reduced. In addition, the use of at least one deterministic quantity for determining the duration of the first time interval makes it possible to influence in a controlled manner the start of the data transmission, and therefore also the interference level, which can be characterized by a noise rise. A reduction in noise rise therefore causes a reduction in interference level and vice versa.

A deterministic quantity is distinguished from a randomly generated quantity in that a deterministic quantity is already theoretically fixed before its measurement or calculation, i.e. repeated determination of a deterministic quantity always leads to the same result under the same boundary conditions. Deterministic therefore means the opposite of random or stochastic.

If the deterministic quantity is a priority class of the transmitting station, this has the advantage that different transmitting stations can be allocated different first time intervals in dependence on the particular priority class. In this way, therefore, data transmission can be made possible preferentially for a transmitting station used for transmitting a time-critical service, for example, an emergency call, as compared to a transmitting station which transmits, for example, a simple text message.

It is also advantageous if the deterministic quantity is at least one time-variable parameter which is specific to the transmitting station and/or the radio link. In this way the start of the data transmission can always be adapted to the current conditions of a transmission channel or to the specific requirements of the transmitting station. It is especially preferred if the first time interval depends on a combination of the priority class and the specific parameter.

The at least one time-variable parameter specific to the transmitting station is preferably a state of a data memory of the data to be transmitted and/or a charge state of an energy source supplying the transmitting station. If the data memory of the transmitting station is almost full and/or the battery is almost empty, a shortest possible first time interval can be selected for the transmitting station, to prevent the data memory from overflowing and/or the data transmission from not being completed because the battery is empty.

It is especially advantageous if the at least one time-variable parameter specific to the data link relates to transmission characteristics of a physical channel used for the radio link. For example, if the transmitting station requires very little transmission power for its data transmission because of good transmission characteristics, a shortest possible first time interval can be used for that station, since only a small increase in the interference level results from its data transmission.

The expiry of the first time interval is advantageously determined by comparison of a value of a counter with a limit value. Instead of a typical counter which is increased or decreased by a predefinable value at given time intervals, any other device suitable for determining a time interval may, of course, be used. For example, a capacitor may be charged and in this case the comparison with the limit value consists in monitoring the charge state of the capacitor.

A shortest possible time interval may be achieved, for example, in that the above-described counter is counted more quickly, or in that the limit value is selected especially low or high in dependence on a counting direction of the counter.

The transmitting station advantageously receives from the receiving station a value for a minimum duration for the data transmission.

It is useful if the minimum duration depends on the priority class of the transmitting station.

It is advantageous if the data transmission is interrupted only after the expiry of an individual transmission time interval specific to the transmitting station, the duration of which depends on the deterministic quantity, while the radio link continues to be maintained. In order to reduce the interference level at the receiving station it is advantageous, additionally to the individual first time interval which precedes the start of the data transmission, to determine a maximum duration of the data transmission in dependence on, for example, the priority class. A further shortening of the transmission duration in dependence on the time-variable parameter specific to the transmitting station can additionally diminish the interference level or the noise rise, or reduce fluctuations.

A preferred embodiment of the invention provides that the radio link continues to exist after an interruption of the data transmission, and a continuation of the data transmission begins after the expiry of a second time interval specific to the transmitting station, the duration of which depends on the deterministic quantity.

The transmitting station according to the invention and the receiving station according to the invention possess all the features that are required for executing the method according to the invention.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram illustrating a data transmission between a transmitting station and a receiving station;

FIG. 2 is a flowchart of the data transmission between the transmitting station and the receiving station according to FIG. 1;

FIG. 3 is a graph of the time progression for determining the start of the data transmission of the transmitting station according to FIG. 1 and of a further transmitting station, and

FIG. 4 is a graph of the time progression of the data transmission, the ending of the data transmission and the further start of a data transmission of the transmitting station according to FIG. 1.

### DETAILED DESCRIPTION OF THE PREFERRED EMBODIMENT

Reference will now be made in detail to the preferred embodiments of the present invention, examples of which are illustrated in the accompanying drawings, wherein like reference characters refer to like elements throughout.

A transmitting station is any station which can transmit signals. In the following exposition a subscriber station is regarded as the transmitting station. A subscriber station is, for example, a mobile telephone or a mobile device for transmitting image and/or sound data, for sending fax, Short Message Service SMS and e-mail communications and for Internet access. It therefore comprises a general transmitting and/or receiving unit of a radio communication system, in particular a base station.

In the following exposition a base station is regarded as the receiving station, without being restricted thereto.

A receiving station may, of course, also be a mobile station or any other station having a receiving device for receiving signals transmitted via a radio link.

The invention may advantageously be used in any desired radio communication system. Radio communication systems are understood to mean any system in which a data transmission takes place between stations via a radio interface. The data transmission may take place both bidirectionally and unidirectionally. Radio communication systems are, in particular, any mobile radio system conforming, for example, to the GSM (Global System for Mobile Communication) or the UMTS (Universal Mobile Telecommunication System) standard. Ad hoc networks and future mobile radio systems, for example, fourth-generation systems, should be understood to be included in radio communication systems.

The invention is described below with reference to the example of a mobile radio system conforming to the UMTS standard, without, however, being restricted thereto.

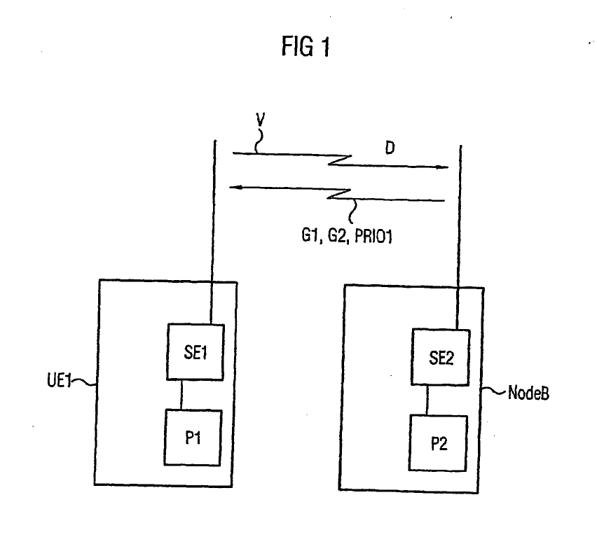

FIG. 1 represents schematically a data transmission D from a subscriber station UE1 to a base station NodeB via a radio link V. The subscriber station UE1 and the base station NodeB each have at their disposal a transmitting and receiving unit SE1, SE2, and a processor P1, P2 for controlling the respective transmitting and receiving unit SE1, SE2 and a respective data transmission. While the radio connection V is being established but before the start of a data transmission D to the base station NodeB, the base station NodeB transmits to the subscriber station UE1, for example via a broadcasting channel, a first limit value G1, a second limit value G2 and a priority class PRIO1 of the subscriber station UE1. Alternatively, the first and second limit values G1, G2 may be fixed in advance and stored permanently at the subscriber station UE1. In this case only the priority class PRIO1 is transmitted to the subscriber station UE1.

The start of the data transmission D of the subscriber station UE1 is determined by the subscriber station UE1 by its processor P1. Of course, the base station NodeB may also determine the start of the data transmission D by its processor P2 and transmit a corresponding instruction for the data transmission D to the subscriber station UE1.

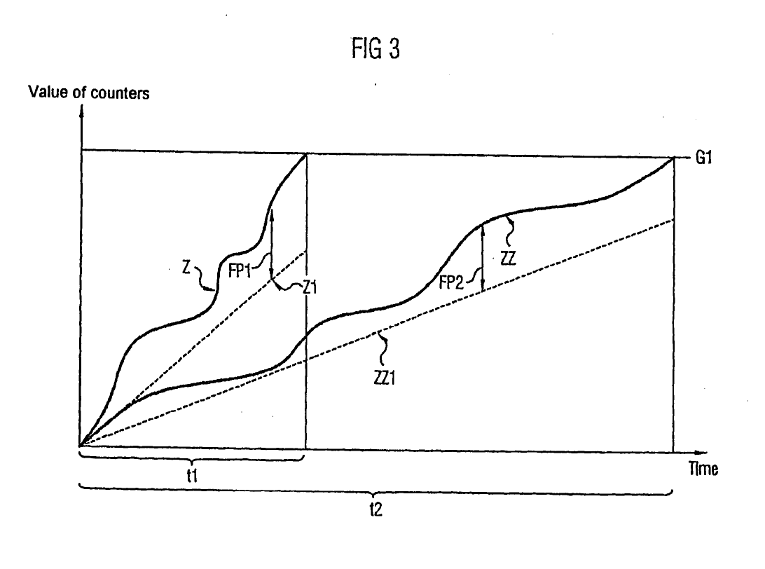

The determination of the start of the data transmission D causes a first time interval t1 which is specific to the subscriber station UE1 to elapse between the establishment of the radio link V and the start of the data transmission D (cf. FIG. 3). The first time interval t1 depends solely on a deterministic quantity, i.e. in order to determine the duration of the first time interval t1 no random values are used, in contrast to the access procedure known from the DRAC protocol.

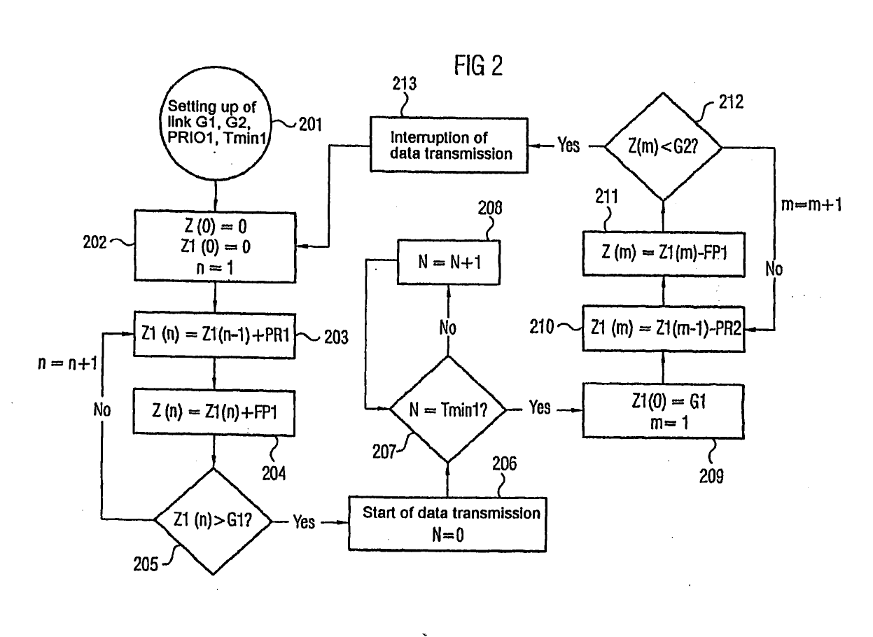

The duration of the first time interval t1 depends in this embodiment on the priority class PRIO1 of the subscriber station UE1 and on at least one time-variable parameter FP1 specific to the subscriber station UE1 and/or to the radio link V, and on the first limit value G1 (see the description relating to FIGS. 2 and 3).

The specific parameter FP1 is, for example, a state of a data memory of the subscriber station UE1, i.e., for example, a capacity utilization level of the data memory, a charge state of the energy source, for example, a preferably rechargeable battery, or a transmission characteristic of a physical channel used for the data transmission D, for example, a required transmitting power of the subscriber station UE1.

The deterministic quantity may, of course, depend on any combination of specific parameters.

FIG. 2 shows schematically the logic sequence of the establishment of the radio link V up to the start of the data transmission D of the subscriber station UE1, the data transmission D and an interruption of the data transmission D.

In box 201 the establishment of the radio link V and the transmission of the first and second limit values G1, G2, of the priority class PRIO1 and of a minimum duration Tmin1 of the data transmission D from the base station NodeB to the subscriber station UE1 takes place. Then, in box 202, a main counter Z and a sub-counter Z1 are set to a starting value, for example zero. An iteration variable n is set to the value 1. In box 203 the sub-counter is increased by a value PR1, which depends on the priority class PRIO1. A high priority class causes a greater value PR1 than a low priority class and therefore yields a shorter first time interval t1 than the low priority class. The first time interval begins with box 201 and ends when box 206 is reached.

The subscriber station UE1 derives the value PR1 from a table, for example with reference to the received priority class PR1O1. The subscriber station UE1 receives the table, together with updates of the table, via a broadcasting channel, for example. The value PR1 may, of course, also be transmitted via an individual link from the base station NodeB to the subscriber station UE1.

In box 204 the value of the main counter Z is formed from the sum of the sub-counter Z1 and the specific parameter FP1. After a comparison of the value of the main counter Z with the first limit value G1, a resetting of the sub-counter Z1 and the main counter Z is carried out, if Z<G1, by running boxes 203 and 204. If Z>G1 the data transmission D is begun in box 206.

With the start of the data transmission D a further counter N is set to zero. This counter serves to ensure that the data transmission D has at least the minimum duration Tmin1. For this purpose the further counter N is compared in box 207 with the minimum duration Tmin1 and is increased by 1 in box 208 until the condition N=Tmin1 is fulfilled.

If the further counter N is equal to the minimum duration Tmin1, in box 209 the sub-counter Z1 is set to the limit value G1 as the starting value and a further iteration variable m is set to the value 1. In box 210 the sub-counter Z1 is decreased by a value PR2 determined on the basis of the priority class PRIO1. This value PR2 may be determined with reference to a table in the same way as the value PR1 used in box 203, or transmitted from the base station NodeB.

In box 211 the value of the main counter Z is calculated by subtraction of the specific parameter FP1 from the sub-counter Z1 and compared in box 212 with the second limit value G2. If the value of the main counter Z>G2, the counter statuses are again calculated in boxes 210 and 211. If Z<G2, the data transmission D is interrupted in box 213 and, if further data is waiting for transmission or the radio link has not been ended on the network side or the subscriber side, the above-described procedure begins again in box 202.

For a further running of the procedure, or even during a run of the procedure, new first and second limit values, a new priority class and a new minimum duration of the data transmission may, of course, be transmitted from the base station NodeB to the subscriber station UE1.

The values PR1 and PR2, determined on the basis of the priority class PRIO1 and used to calculate the sub-counter Z1 in boxes 203 and 210, may, of course, be equal or different. In this way different maximum durations may be fixed for the first time interval t1 and for a transmission time interval t3, which lasts from the start of the data transmission in box 206 until the interruption of the data transmission in box 213. Furthermore, different specific parameters FP1 may be used or combined in boxes 204 and 211. Preferably, however, the same specific parameters FP1 are used or combined in boxes 204 and 211.

Equivalently to the above-described embodiment, the start of the data transmission may also, of course, be determined by a decrease of the sub-counter Z1 and of the main counter Z resulting from a predefinable start value, and a failure to meet a limit value. Correspondingly, sub-counter Z1 and main counter Z may be increased until a corresponding limit value is exceeded, to end the data transmission. Equally, different main and sub-counters may be used for the starting and ending of the data transmission.

The base station NodeB explicitly specifies at least one of the limit values G1, G2, while the other limit value G1, G2 may, of course, also be specified relative to the explicitly specified limit value G1, G2.

The selection of the limit values G1, G2, or the difference between the limit values G1, G2 depends, for example, on a noise rise at the base station NodeB, which is defined by the ratio of the total received power to the power of the thermal noise. Because the invention makes it possible to reduce a probability of simultaneous data transmission by different subscriber stations through a statistical distribution of the start of the data transmission and the duration of the transmission in each case, the noise rise at the base station NodeB can be controlled and therefore optimized by adaptation of the limit values G1, G2 on the basis of a measured noise rise.

For example, if the noise rise is greater than a desired reference value, e.g. 6 dB, the first limit value G1 may be increased and/or the difference from the second limit value G2 reduced.

The method according to the invention makes lower signaling demands than the DRAC protocol mentioned in the introduction because all the subscriber stations jointly use the first and second limit values G1, G2, and has shorter signal delays because the limit values G1, G2 are controlled directly by the base station NodeB, whereas the signaling of the DRAC protocol is controlled by a Radio Resource Controller (RNC) which must first send its signals to a base station for onward transmission prior to a transmission to a subscriber station. Furthermore, according to the invention subscriber-specific quantities are also used, so that the individual requirements of the subscriber stations can be taken into account for the start and ending of a data transmission. A subscriber station with good transmission conditions, for example a subscriber station which requires little transmission power, can be treated preferentially, i.e. can begin its data transmission more quickly and/or transmit data for longer, than a subscriber station with poor transmission conditions. In the same way, a subscriber station with an almost full data memory can be given preference in order to prevent this subscriber station from having to interrupt a data flow from higher layers when the data memory is full.

A further advantage of the method according to the invention is that, through the use of a priority class, both a maximum time period up to a start of a data transmission and a maximum duration of the data transmission can be fixed for each subscriber station.

FIG. 3 represents schematically the behavior of the sub-counter Z1 and the main counter Z of the subscriber station UE1, and the first limit value G1. For a further subscriber station the behavior of a corresponding further sub-counter ZZ1 and of a corresponding further main counter ZZ is also shown. The values of the sub-counters Z1, ZZ1 increase linearly with time and ensure a maximum duration up to the start of the respective data transmission. From the steeper gradient of the sub-counter Z1 in comparison to the further sub-counter ZZ1, it can be read off that the subscriber station UE1 has a higher priority class PRIO1 than the further subscriber station.

The particular main counter value Z, ZZ is yielded by addition of the respective sub-counter Z1, ZZ1 to the respective specific parameter FP1, FP2. The subscriber station UE1 already begins its data transmission D after the first time interval t1, whereas the further subscriber station begins its data transmission only after a longer further time interval t2. In practice, typical maximum durations of the first and further time intervals t1, t2 are a few tens of milliseconds.

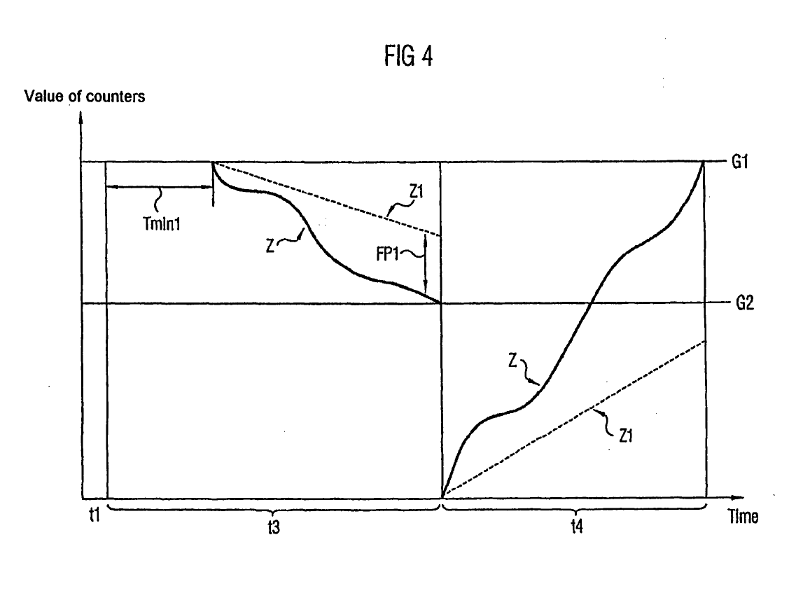

FIG. 4 represents schematically the course of the data transmission D of the subscriber station UE1 and an interruption of the data transmission D, and a resetting of the counters Z, Z1 after the interruption of the data transmission D. As can be seen from FIG. 3, the subscriber station UE1 begins its data transmission D after the expiry of the first time interval t1. The data transmission D lasts at least the minimum duration Tmin1. Only after expiry of the minimum duration Tmin1 are the sub-counter Z1 and the main counter Z decreased again in dependence on the priority class PRIO1 and the specific parameter FP1 until the second limit value G2 has been reached or passed below. The data transmission D lasts in total the transmission time interval t3. After the interruption of the data transmission D the sub-counter Z1 and the main counter Z are increased again, while the radio link V continues to be maintained, until, after the lapse of a second time interval t4, a continuation of the data transmission takes place.

The invention can, of course, also be used if the subscriber station UE1 carries out a data transmission to a plurality of base stations. This occurs, for example, in the case of a cell change in so-called soft handover.

In soft handover, the subscriber station UE1 receives a first and second limit value and/or a priority class and/or a minimum duration of the data transmission from each of a plurality of base stations. The subscriber station now uses, for example, the values it has received from the base station with the largest noise rise. Of course, the subscriber station may also form an optionally weighted mean for the limit values and/or the priority class and/or the minimum duration from all the values received. In the same way, the transmission characteristics of a physical channel, or a corresponding mean value formed across all the physical channels, may be used for the specific parameter.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-12. (canceled)

13. A method for transmitting data from a transmitting station to a receiving station via a radio link, comprising:
establishing the radio link between the transmitting station and the receiving station; and
starting the data transmission at the transmitting station only after the transmitting station has detected expiration of an individual first time interval specific to the transmitting station, the individual first time interval having a duration depending on at least one deterministic quantity.

14. A method according to claim 13, wherein the deterministic quantity is a priority class of the transmitting station.

15. A method according to claim 14, wherein the deterministic quantity is at least one time-variable parameter specific to at least one of the transmitting station and the radio link.

16. A method according to claim 15, wherein the at least one time-variable parameter specific to the transmitting station is at least one of a state of a data memory of the data to be transmitted and a charge state of an energy source supplying the transmitting station.

17. A method according to claim 15, wherein the at least one time-variable parameter specific to the radio link relates to transmission characteristics of a physical channel used for the radio link.

18. A method according to claim 17, wherein the expiration of the first time interval is determined by a comparison of a value of a counter with a limit value.

19. A method according to claim 18, further comprising receiving at the transmitting station from the receiving station a value for a minimum duration for the data transmission.

20. A method according to claim 19, wherein the minimum duration depends on the priority class of the transmitting station.

21. A method according to claim 20, further comprising interrupting the data transmission, while maintaining the radio link, only after expiration of an individual transmission time interval specific to the transmitting station, the individual transmission time interval having duration depending on the deterministic quantity.

22. A method according to claim 21, further comprising, after said interrupting of the data transmission and while the radio link continues to be maintained, beginning continuation of the data transmission after expiration of an individual second time interval specific to the transmitting station, the individual second time interval having a duration which depends on the deterministic quantity.

23. A transmitting station capable of transmission to a receiving station, comprising:
means for establishing a radio link between the transmitting station and the receiving station; and
means for transmitting data from the transmitting station to the receiving station only after the transmitting station detects expiration of an individual first time interval specific to the transmitting station, the individual first time interval having a duration depending on at least one deterministic quantity.

24. A receiving station capable of receiving a transmission from a transmitting station, comprising:
means for establishing a radio link between the transmitting station and the receiving station; and
means for transmitting at least one deterministic quantity to the transmitting station, a data transmission from the transmitting station to the receiving station taking place only after the transmitting station detects expiration of an individual first time interval specific to the transmitting station, the individual first time interval having a duration depending on at least one deterministic quantity.
